(19) United States
(12) Patent Application Publication
(10) Pub. No.: US 2026/0029239 A1
(43) Pub. Date: Jan. 29, 2026

(54) TECHNIQUES FOR ELECTRIFIED VEHICLE RANGE PREDICTION BASED ON PATTERN RECOGNITION

(71) Applicant: FCA US LLC, Auburn Hills, MI (US)

(72) Inventors: Ali Sina Shojaei, Auburn Hills, MI (US); Feisel Weslati, Auburn Hills, MI (US)

(21) Appl. No.: 18/782,645

(22) Filed: Jul. 24, 2024

(51) Int. Cl. G01C 21/34; G06F 18/10; G06F 18/40

(52) U.S. Cl. CPC G01C 21/3469; G01C 21/3492; G06F 18/10; G06F 18/40

(57) ABSTRACT

A range estimation technique for an original equipment manufacturer (OEM) electrified vehicle involves determining, by an OEM computing server, a route for the electrified vehicle and a set of operating parameters of the electrified vehicle and historical data for other OEM vehicles traveling along the determined route or another route that is similar to the determined route, segmenting the determined route into a plurality of route segments and, for each route segment, identifying one or more combinations of OEM vehicles that traveled that route segment, and estimating a range depletion for each route segment based on the historical data for the respective identified combinations of OEM vehicles and a total range depletion for the determined route based on the estimated range depletions for each route segment.

### FIELD

The present application generally relates to electrified vehicles and, more particularly, to range prediction or estimation techniques for electrified vehicles based on pattern recognition.

### BACKGROUND

Electrified vehicles include at least one electric traction motor powered by a high voltage battery system, which is capable of storing a finite amount of energy. “Range anxiety,” defined as the driver's perception of the risk of running out of propulsive or traction energy, remains a key obstacle in the way of wide marketability of electrified vehicles. A key contributor to range anxiety is inaccuracy and variability of the displayed remaining range. One conventional range estimation technique involves two steps: (1) estimating the total energy consumption of the electrified vehicle in the future, and (2) comparing the estimated future energy consumption with the remaining energy of a battery system of the electrified vehicle. Both of these steps are challenging and are prone to significant errors. Accordingly, while such conventional electrified vehicle range estimation techniques do work for their intended purpose, there exists an opportunity for improvement in the relevant art.

### SUMMARY

According to one example aspect of the invention, a range estimation system for an electrified vehicle associated with an original equipment manufacturer (OEM) is presented. In one exemplary implementation, the range estimation system comprises a computing server associated with the OEM and configured to determine a route for the electrified vehicle and a set of operating parameters of the electrified vehicle, determine historical data for other OEM vehicles traveling along the determined route or another route that is similar to the determined route, segment the determined route into a plurality of route segments, for each route segment, identify one or more combinations of OEM vehicles that traveled that route segment, estimate a range depletion for each route segment based on the historical data for the respective identified combinations of OEM vehicles, and estimate a total range depletion for the determined route based on the estimated range depletions for each route segment, and a control system of the electrified vehicle, the control system being configured to determine and display an estimated range of the electrified vehicle based on the estimated total range depletion provided by the computing server.

In some implementations, the computing server is further configured to apply pattern recognition machine learning model to identify the one or more combinations of OEM vehicles that traveled each route segment. In some implementations, the computing server is configured to estimate the range depletion for each route segment and the total range depletion for the determined route in real-time. In some implementations, the computing server is further configured to update the pattern recognition machine learning model in real-time.

In some implementations, the identified combinations of OEM vehicles include OEM vehicles that traveled particular route segments at different historical times. In some implementations, the computing server is further configured to construct a data pool of the historical data and to continuously receive information from the plurality of OEM vehicles to augment the data pool. In some implementations, the computing server is further configured to clean or filter the information received from the plurality of OEM vehicles before adding it to the data pool. In some implementations, the computing server is further configured to verify that the data pool of the historical data is sufficiently broad or diverse before using it to determine the historical data for the other OEM vehicles.

According to another example aspect of the invention, a range estimation method for an electrified vehicle associated with an OEM is presented. In one exemplary implementation, the range estimation method comprises determining, by a computing server associated with the OEM, a route for the electrified vehicle and a set of operating parameters of the electrified vehicle, determining, by the computing server, historical data for other OEM vehicles traveling along the determined route or another route that is similar to the determined route, segmenting, by the computing server, the determined route into a plurality of route segments, for each route segment, identifying, by the computing server, one or more combinations of OEM vehicles that traveled that route segment, estimating, by the computing server, a range depletion for each route segment based on the historical data for the respective identified combinations of OEM vehicles, estimating, by the computing server, a total range depletion for the determined route based on the estimated range depletions for each route segment, and determining and displaying, by a control system of the electrified vehicle, an estimated range of the electrified vehicle based on the estimated total range depletion provided by the computing server.

In some implementations, the range estimation method further comprises applying, by the computing server, a pattern recognition machine learning model to identify the one or more combinations of OEM vehicles that traveled each route segment. In some implementations, the estimating of the range depletion for each route segment and the total range depletion for the determined route are performed in real-time. In some implementations, the range estimation method further comprises updating, by the computing server, the pattern recognition machine learning model in real-time.

In some implementations, the identified combinations of OEM vehicles include OEM vehicles that traveled particular route segments at different historical times. In some implementations, the range estimation method further comprises constructing, by the computing server, a data pool of the historical data and continuously receiving, by the computing server, information from the plurality of OEM vehicles to augment the data pool. In some implementations, the range estimation method further comprises cleaning or filtering, by the computing server, the information received from the plurality of OEM vehicles before adding it to the data pool. In some implementations, the range estimation method further comprises verifying, by the computing server, that the data pool of the historical data is sufficiently broad or diverse before using it to determine the historical data for the other OEM vehicles.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of an electrified vehicle having an example range estimation system according to the principles of the present application;

FIG. 2 is a flow diagram of an example range estimation method for an electrified vehicle, such as the electrified vehicle of FIG. 1, according to the principles of the present application; and

FIG. 3 is a visual demonstration of the formation of vehicle reference pool and segmental reference combinations according to the principles of the present application.

### DESCRIPTION

As previously discussed, high voltage battery systems are limited to storing a finite amount of energy, and the corresponding range anxiety remains a key obstacle in the way of wide marketability of electrified vehicles. A key contributor to range anxiety is inaccuracy and variability of the displayed remaining range. One conventional range estimation technique involves two steps: (1) estimating the total energy consumption of the electrified vehicle in the future, and (2) comparing the estimated future energy consumption with the remaining energy of a battery system of the electrified vehicle. Both of these steps are challenging and are prone to significant errors. More particularly, estimating the future energy consumption of an electrified vehicle using conventional methods requires a-priori knowledge about all factors that contribute to the energy consumption. The electrified powertrain and, more specifically, the electric traction motor(s), takes the largest share of the energy consumption.

Predicting the future energy consumption of the propulsion requires advance knowledge of vehicle acceleration, speed, vehicle weight and road topology, etc., from which only vehicle weight and road topology are known with reasonable certainty, while vehicle acceleration and speed can vary instantaneously and are generally unpredictable. In addition, factors such as road congestion and ambient conditions can significantly affect the energy consumption of the propulsion system. Similarly, determining the remaining energy of the high voltage battery system of the electrified vehicle incurs various challenges, which are mostly associated to determining the remaining energy of the battery. In contrast, determining the remaining energy in the form of stored liquid fuel (in the case of hybrid electric vehicles, or HEVs, having an internal combustion engine) or in the form of stored hydrogen (in the case of fuel cell electric vehicles, or FCEVs) is typically more straightforward.

Determining the remaining energy of the high voltage battery pack or system of an electrified vehicle is difficult because the temperature of a conventional high voltage battery system affects its energy storage capability. More specifically, cold battery cells store less energy compared to warm battery cells. In addition, the temperature imbalance of the high voltage battery system, defined as the variation in the temperature amongst the battery cells of the high voltage battery system, also affects the energy storage capacity of the high voltage battery system. This temperature imbalance of the high voltage battery system is also typically difficult to detect. Furthermore, aged battery cells have a lower energy storage capacity compared to newer battery cells, and this creates an inaccuracy in the estimation of remaining energy, both for the same electrified vehicle over its lifetime, and comparing one electrified vehicle to another (e.g., having the same high voltage battery system).

In addition to the conventional range estimation technique previously discussed herein, there also exist machine learning based range estimation techniques for electrified vehicles. These machine learning based range estimation techniques are generally divided into two types. In a first type, machine learning is used to estimate the evolution of battery states that affect the battery energy capacity, such as temperature. This estimation is based on historical data from the same high voltage battery system, as well as historical data about the operation of the electrified vehicle and prediction of external factors such as ambient temperature. This type of machine learning method relies on historical or instantaneous energy consumption of the electrified vehicle as input.

In a second type, historical datasets from the previous trips of the electrified vehicle are used to train a machine learning algorithm. These datasets include factors contributing to energy consumption (accelerator pedal position, brake pedal position, selected gear, air conditioning system state, road topology, etc.), as well as the achieved range from previous trips. By training the machine learning algorithms on historical trip datasets, this type of method aims to be able to associate the operation state of the electrified vehicle in its current trip to the most similar historical data and predict the remaining range accordingly. The main drawback of the this second type of machine learning method is its reliance on historical data from the same electrified to directly determine the remaining vehicle range. This means that if the target or host vehicle has not previously performed an exact same trip or a trip that is sufficiently similar to its current trip, the estimated range can be significantly inaccurate. For example, if the target vehicle is driven on a mountainous road for the first time, relying on historical data from its previous trips on flat roads to estimate range will be inaccurate.

Accordingly, improved range estimation techniques for electrified vehicles are presented herein. These improved techniques utilize machine learning and pattern recognition (e.g., a pattern recognition machine learning model) to estimate electrified vehicle range more accurately than the conventional techniques previously described herein. These improved techniques using a combination of real-time and historical information from a large pool of reference (i.e., original equipment manufacturer, or OEM) vehicles travelling at least one segment of the same route as the host or target vehicle. Alternatively, the same data from OEM vehicles traveling a similar route to the target vehicle could be used. Statistical and data management techniques are applied to the acquired data to filter/clean the data, which is stored globally or locally, with respect to an operating region of the relevant vehicles. The data can be continuously collected over time and the database of stored data can be updated to improve future range estimation accuracy. Potential benefits include more accurate range estimation and decreased range anxiety for the driver.

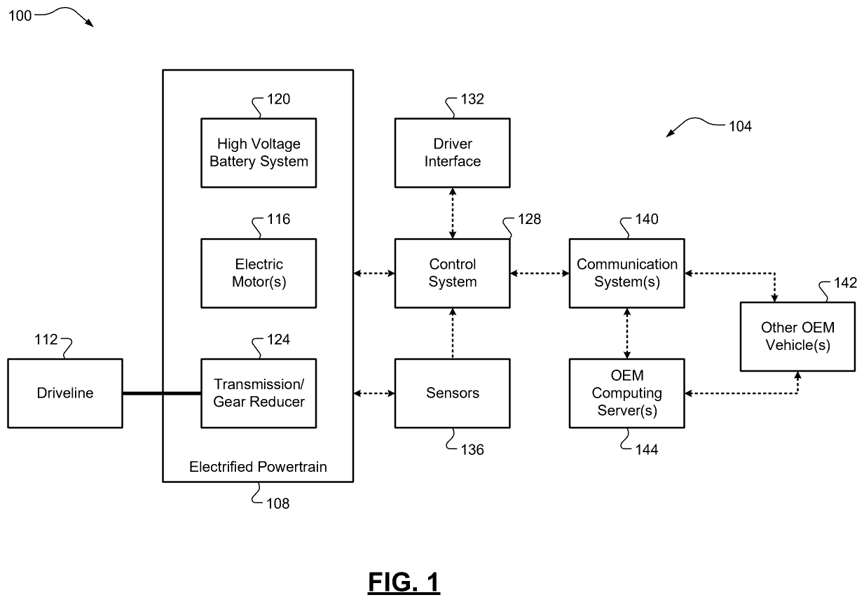

Referring now to FIG. 1, a functional block diagram of an electrified vehicle 100 having an example range estimation system 104 according to the principles of the present application is illustrated. The electrified vehicle 100 includes an electrified powertrain 108 configured to generate and transfer torque to a driveline 112 for propulsion. The electrified powertrain 108 includes at least one electric motor 116 (e.g., a three-phase electric traction motor) powered by a high voltage battery pack or system 120. The electrified powertrain 108 also includes a transmission or gear reducer 124 configured to transfer the drive torque from the electric motor(s) 116 to the driveline 112. While an electric-only configuration of the electrified vehicle 100 (a battery electric vehicle, or BEV) is illustrated, it will be appreciated that the electrified powertrain 108 could further include another energy generator, such as an internal combustion engine (a hybrid electric vehicle, or HEV) and/or a hydrogen or other suitable fuel cell system (a fuel cell electric vehicle, or FCEV).

A control system 128 controls operation of the electrified vehicle 100, which primarily includes controlling the electrified powertrain 108 to generate a desired amount of drive torque to satisfy a driver torque request provided via a driver interface 132 (e.g., an accelerator pedal). A plurality of sensors 136 are configured to measure operating parameters of the electrified vehicle 100, such as, but not limited to, speeds/accelerations, pressures, temperatures, and electrical parameters (voltage, current, etc.). The sensors 136 could also include other vehicle systems, such as a navigation/maps system. The control system 128 is also configured to communicate with other devices/systems (e.g., other OEM vehicles 142) using one or more communication systems 140 each configured for communication via a particular communication network or medium. For example, the communication systems 140 could include a long-range cellular communication transceiver and a short-range wireless communication (e.g., Bluetooth) transceiver. One particular communication by the control system 128 via the communication system(s) 140 is with a set of one or more OEM computing servers 144 that store/analyze data provided by the plurality of OEM vehicles 142.

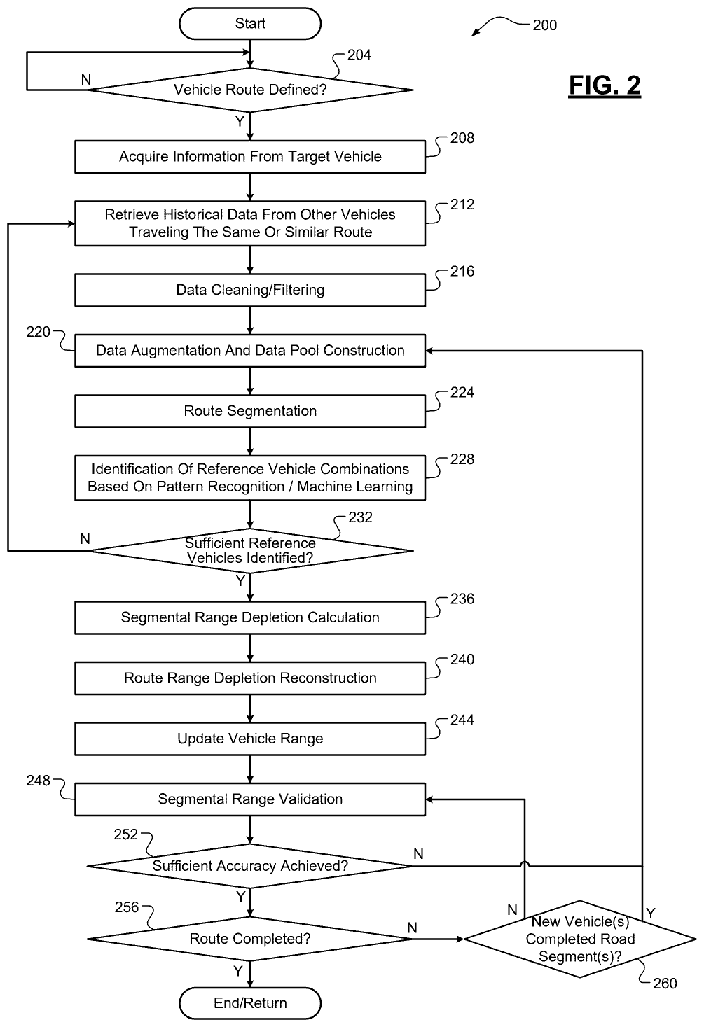

As previously discussed, the range estimation techniques presented herein include estimating the range of a target or host vehicle (e.g., electrified vehicle 100) using the combination of real-time, and historical information from a pool of reference OEM vehicles 142 travelling one or all segments of the same route as that of the target vehicle. This pool or information or data can be stored, for example, at the OEM computing servers 144. Alternatively, real-time and historical data from other OEM vehicles 142 142 travelling not the same but a different, significantly similar route to that of the target vehicle can be used. The techniques continuously monitor and acquire data from the OEM vehicles 142 travelling along the routes of interest. By applying statistical and data management techniques, the acquired data will be cleaned (noise filtered, duplicate data removed or discarded, etc.) and stored either globally or locally, with respect to the operating region of the vehicles. The pattern recognition machine learning model could also be updated or trained in real-time, whereas conventional energy usage models are only pre-trained. In one exemplary embodiment, the following steps illustrated in FIG. 2 and described below can be taken to predict or estimate the range of the target vehicle as it embarks on its route.

Referring now to FIG. 2, a flow diagram of an example range estimation method 200 for an electrified vehicle, such as the electrified vehicle 100 of FIG. 1, according to the principles of the present application is illustrated. While the method 200 specifically references the electrified vehicle 100 and its components for descriptive/illustrative purposes, it will be appreciated that the method 200 could be applicable to any suitably configured electrified vehicle (BEV, HEV, FCEV, etc.). The method 200 begins at 204. At 204, the control system 128 determines whether the route for the electrified vehicle 100 is defined. This could be, for example, a predefined or preset route by a driver of the electrified vehicle 100. It will be appreciated that the vehicle route could also be determined/defined in any other suitable manner, such as automatically determined and defined by the control system 128 based on other parameters (e.g., time of day/week and other historical data). It will be appreciated that step 204 could optionally further include determining whether any other suitable preconditions are satisfied, such as the electrified vehicle 100 being fully operational without any malfunctions or faults that would negatively impact or otherwise inhibit the operation. When true, the method 200 proceeds to 208. When false, the method 200 ends or returns to 204.

The following steps could be performed by the control system 128, by the OEM computing server(s) 144, or by some combination thereof (e.g., distributed tasks). At 208, information from the target vehicle is acquired (e.g., by the control system 128). This will include, amongst other information, the real-time state of various vehicle systems and history of driver inputs. At 212, real-time information from other OEM vehicles 142 on the same route or a similar route ahead of the target vehicle is acquired (e.g., by the OEM computing server(s) 144). At 216, the acquired data from the other OEM vehicles 142 is cleaned or filtered (e.g., by the OEM computing server(s) 144). At 220, the cleaned/filtered real-time data is augmented with historical datasets from other OEM vehicles 142 previously travelling the same route or a similar route either partially or wholly, to construct a data or information pool (e.g., by the OEM computing server(s) 144). At 224, the vehicle route is segmented or divided into a plurality of segments (e.g., by the OEM computing server(s) 144). This segmentation could be performed using any suitable segmentation technique, and the length and number of segments could be defined based on the various factors including, but not limited to, the topological features of the route and availability of sufficient data from other vehicles for the desired segmentation.

At 228, methods of pattern recognition machine learning (e.g., a trained model) are applied to the information from the target vehicle and the data pool to identify reference vehicle combinations for each segment of the route (e.g., by the OEM computing server(s) 144). At 232, it is determined whether a sufficient number of reference vehicles have been identified to construct a sufficient data pool. When true, the method 200 proceeds to 236. When false, the method 200 returns to 212. At 236, the range depletion of the target vehicle in each segments is calculated accordingly from the reference vehicle combinations (e.g., by the OEM computing server(s) 144). At 240, the total range depletion throughout the route is calculated (e.g., by the OEM computing server(s) 144). At 244, the predicted or estimated total remaining range of the target vehicle is calculated and communicated to the target vehicle (e.g., by the OEM computing server(s) 144 and to the control system 128). At 248, segmental range validation or analysis is performed. This includes, for example, determining a degree of accuracy of the estimated vehicle range for a particular segment or set of segments. At 252, it is determined whether a sufficient degree of accuracy has been achieved (e.g., satisfying an accuracy threshold). When true, the method 200 proceeds to 256. When false, the method 200 returns to 220 for further augmentation of the data pool.

Finally, at 256, it is determined whether the vehicle route is completed. When true, the method 200 ends. When false, the method 200 proceeds to 260 where it is determined whether new vehicle(s) have completed any of the road segments. When true, the method 200 returns to 220 for augmentation of the data pool. When false, the method 248 returns to 248 for segmental range validation. In other words, as the target vehicle progresses on the route, the techniques monitor for any variation in its operating conditions and evaluates the accuracy of segmental range depletions against real-time data, which is also referred to as segmental range validation. Accordingly, the techniques could select a different reference vehicle combination for the remainder of the route segments, retrieve other historical datasets to augment the data pool, or re-calculate the segmentation of the route differently to increase accuracy. The techniques continuously acquires information from other vehicles on the route in real-time and where applicable replaces historical datasets used within the data pool with more recent information as they become available to eliminate possible noise from external factors affecting the operating state of the vehicles. The techniques also continuously acquire information about the conditions of the route and in case of any significant variations seeks to maintain the range prediction accuracy by updating the data pool, changing the reference vehicle combinations of upcoming segments, and re-calculating the route segmentation as needed.

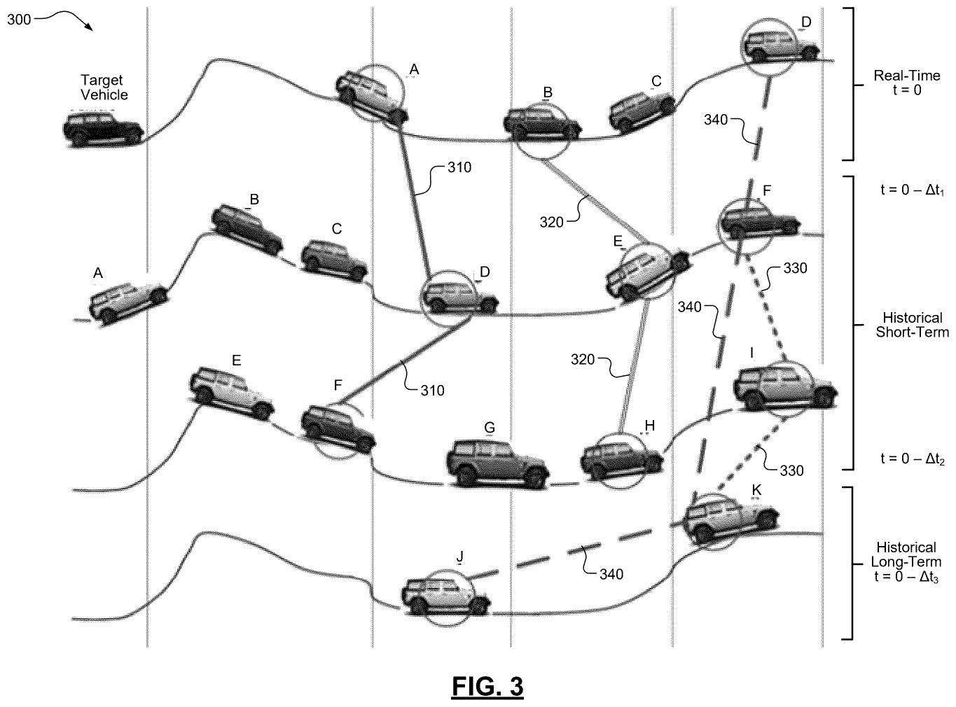

Referring now to FIG. 3, a visual demonstration 300 of the formation of vehicle reference pool and segmental reference combinations according to the principles of the present application is illustrated. Specifically, four snapshots of a specific route are illustrated: (1) a real-time dataset (time t=0) and (2)-(4) three historical datasets at previous times Δt₁ to Δt₃. The first snapshot (1) captures the target vehicle on the route. The aim of the range determination logic is to predict or estimate the range depletion of the target vehicle as it travels through the route and report it to the vehicle at time t=0. Other OEM vehicles 142 (A-K) travelling the route constitute the pool of reference OEM vehicles 142 for the range estimation logic. The data-acquisition element of the techniques can acquire a host of information from the OEM vehicles 142 travelling the route including their remaining range and all parameters affecting the range. In the first snapshot (1), four other OEM vehicles (A, B, C, and D) are seen ahead of the target vehicle. The second snapshot (2) relates to a previous point in time (t=0−Δt₁) and shows OEM vehicles A-D traveling further back on the route compared to t=0 while OEM vehicles E and F are seen toward the end of the route. Going further back in time to t=0−Δt₂, OEM vehicles E and F can be seen in the third snapshot (3) in addition to newly appearing OEM vehicles G, H, and I, while the fourth snapshot (4) relates to a time when another group of OEM vehicles J and K appear for the first time.

At time t=0, the algorithm retrieves several historical datasets most relevant to the real-time environmental conditions and augments the data with the data acquired in real-time. Accordingly, the logic will divide the route into multiple segments (e.g., four segments in this example) and identifies several reference OEM vehicles 142 for each segment, based on their characteristics and operating conditions, as follows: Segment 1 (reference 310)—OEM vehicles A, D, and F; Segment 2 (reference 320)—OEM vehicles B, E, and H; Segment 3 (reference 330)—OEM vehicles F, I, and K; and Segment 4 (reference 340)—OEM vehicles J, K, and D. The algorithm will then predict the range depletion of the target vehicle for each segment of the route using the reference dataset and updates the predicted range of the target vehicle. As the target vehicle progresses on the route, the algorithm monitors any variation in its operating conditions and evaluates the accuracy of segmental range depletions against real-time data. Accordingly, the algorithm can select a different reference vehicle combination for the route segments, retrieve other historical datasets to augment the pool of the reference vehicles, or segment the route differently to increase accuracy.

It will be appreciated that the terms “controller” and “control system” as used herein refers to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A range estimation system for an electrified vehicle associated with an original equipment manufacturer (OEM), the range estimation system comprising:
a computing server associated with the OEM and configured to:
determine a route for the electrified vehicle and a set of operating parameters of the electrified vehicle,
determine historical data for other OEM vehicles traveling along the determined route or another route that is similar to the determined route,
segment the determined route into a plurality of route segments,
for each route segment, identify one or more combinations of OEM vehicles that traveled that route segment,
estimate a range depletion for each route segment based on the historical data for the respective identified combinations of OEM vehicles, and
estimate a total range depletion for the determined route based on the estimated range depletions for each route segment; and
a control system of the electrified vehicle, the control system being configured to determine and display an estimated range of the electrified vehicle based on the estimated total range depletion provided by the computing server.

2. The range estimation system of claim 1, wherein the computing server is further configured to apply pattern recognition machine learning model to identify the one or more combinations of OEM vehicles that traveled each route segment.

3. The range estimation system of claim 2, wherein the computing server is configured to estimate the range depletion for each route segment and the total range depletion for the determined route in real-time.

4. The range estimation system of claim 3, wherein the computing server is further configured to update the pattern recognition machine learning model in real-time.

5. The range estimation system of claim 1, wherein the identified combinations of OEM vehicles include OEM vehicles that traveled particular route segments at different historical times.

6. The range estimation system of claim 1, wherein the computing server is further configured to construct a data pool of the historical data and to continuously receive information from the plurality of OEM vehicles to augment the data pool.

7. The range estimation system of claim 6, wherein the computing server is further configured to clean or filter the information received from the plurality of OEM vehicles before adding it to the data pool.

8. The range estimation system of claim 6, wherein the computing server is further configured to verify that the data pool of the historical data is sufficiently broad or diverse before using it to determine the historical data for the other OEM vehicles.

9. A range estimation method for an electrified vehicle associated with an original equipment manufacturer (OEM), the range estimation method comprising:
determining, by a computing server associated with the OEM, a route for the electrified vehicle and a set of operating parameters of the electrified vehicle;
determining, by the computing server, historical data for other OEM vehicles traveling along the determined route or another route that is similar to the determined route;
segmenting, by the computing server, the determined route into a plurality of route segments;
for each route segment, identifying, by the computing server, one or more combinations of OEM vehicles that traveled that route segment;
estimating, by the computing server, a range depletion for each route segment based on the historical data for the respective identified combinations of OEM vehicles;
estimating, by the computing server, a total range depletion for the determined route based on the estimated range depletions for each route segment; and
determining and displaying, by a control system of the electrified vehicle, an estimated range of the electrified vehicle based on the estimated total range depletion provided by the computing server.

10. The range estimation method of claim 9, further comprising applying, by the computing server, a pattern recognition machine learning model to identify the one or more combinations of OEM vehicles that traveled each route segment.

11. The range estimation method of claim 10, wherein the estimating of the range depletion for each route segment and the total range depletion for the determined route are performed in real-time.

12. The range estimation method of claim 11, further comprising updating, by the computing server, the pattern recognition machine learning model in real-time.

13. The range estimation method of claim 9, wherein the identified combinations of OEM vehicles include OEM vehicles that traveled particular route segments at different historical times.

14. The range estimation method of claim 9, further comprising constructing, by the computing server, a data pool of the historical data and continuously receiving, by the computing server, information from the plurality of OEM vehicles to augment the data pool.

15. The range estimation method of claim 14, further comprising cleaning or filtering, by the computing server, the information received from the plurality of OEM vehicles before adding it to the data pool.

16. The range estimation method of claim 15, further comprising verifying, by the computing server, that the data pool of the historical data is sufficiently broad or diverse before using it to determine the historical data for the other OEM vehicles.
